(19) United States
(12) Patent Application Publication
(10) Pub. No.: US 2008/0288504 A1
(43) Pub. Date: Nov. 20, 2008

(54) METHODS, MEDIA, AND SYSTEMS FOR RECORDING AND REPORTING CONTENT USAGE

(76) Inventors: William W. Fisher, III, Lexington, MA (US); Paul Hoffert, Toronto (CA); Devon Copley, Brooklyn, NY (US)

Correspondence Address: WILMERHALE/BOSTON, 60 STATE STREET, BOSTON, MA, 02109, US

(21) Appl. No.: 11/750,120

(22) Filed: May 17, 2007

(51) Int. Cl. G06F 17/30

(52) U.S. Cl. 707/10

(57) ABSTRACT

A content management system distributes items of media content to groups of users. The media is fingerprinted and tracked for reporting purposes. The system uses an algorithm to compensate for multiple content owners. The system can also be configured to provide content while still providing anonymity for actual use.

### TECHNOLOGY AREA

The disclosed subject matter relates to methods, media, and systems for content usage tracking and royalty determination.

### BACKGROUND

The Internet has created a significant demand for users to be able to download and/or stream digital content. This content can include, for example, text, audio clips, still images, motion video, and combinations.

A significant amount of content is available for free over the Internet. However, there are also many services that provide content for fees or royalties. Such compensation can be paid per use, per hit, per download (such as downloading an article from a journal), or on a subscription basis, such as through a monthly or annual fee. Combinations of these approaches are possible, such as providing a monthly fee for a certain number of hits, and then a per hit fee thereafter.

A party can aggregate content and then make payments based on individual uses. For example, a website could offer a catalogue of songs for download, and each time a song is downloaded and paid for, the website pays the appropriate royalties to the artists for the song. Alternatively, a content aggregator could purchase content from a variety of sources on a fixed fee basis or on a percentage basis, and make that content available to users for a fee. For example, some financial services websites aggregate a variety of different services that individual or professional investors can use.

Still another model is used for public performance copyright rights. The right to publicly perform copyrighted material is a right that is severable from other copyright rights, such as the right to copy or the right to make derivative works. Many artists license or assign public performance rights to agencies, such as BMI and ASCAP, that aggregate these rights. BMI and ASCAP then license entities for their catalogs, including site license based on formulas, such as square footage of a restaurant or a number of seats in a stadium. BMI and ASCAP then allocate payments among the artists based on some criteria, such as copies sold and/or number of times the song is played publicly over the radio.

A system that aggregates content from a variety of different owners and uses different types of content can create challenges in tracking usage and fairly compensating content owners.

### SUMMARY

The systems and methods described here are designed for a content distribution system, and typically with a system that aggregates different types of content from different owners and licenses that content to users or a group of users. The license to users can be on an individual basis, but can also be on a group basis, such as to a business, a business campus, a college campus, or a municipal community. The embodiments described here have a number of features and aspects, including an overall system architecture, methods and systems for fingerprinting and tracking usage, methods and systems for distributing royalty payments, and methods for providing some degree of anonymity for users while still recording usage statistics.

Using these embodiments, digital content including, for example, audio, video, television programs, photos, games, documents, and/or voice recordings can be distributed to users in an efficient manner. In addition, these embodiments can also be used to track, count, and/or report content usage, based on which appropriate compensation to owners of the content may be calculated and distributed. Users can be provided with unlimited exchange (e.g., downloading, streaming, and/or copying) of a vast library of licensed digital content with no technical protections or Digital Rights Management (DRM) constraints, while the users may only need to pay, for example, a flat monthly subscription fee.

Other features and advantages will become apparent from the following detailed description, drawings, and claims.

### BRIEF DESCRIPTION OF THE DRAWINGS

The detailed description, including the description of various embodiments of the invention, will be best understood when read in reference to the accompanying figures wherein:

FIG. 1 is diagram providing an overview of a system according to various embodiments of the present inventions;

FIG. 2 is a block diagram illustrating a system according to various embodiments of the present inventions;

FIG. 3 is a flow chart illustrating operations performed by a user tracking system according to various embodiments of the present inventions; and

FIG. 4 is a diagram illustrating a method for determining royalty payments according to various embodiments of the present inventions.

### DETAILED DESCRIPTION

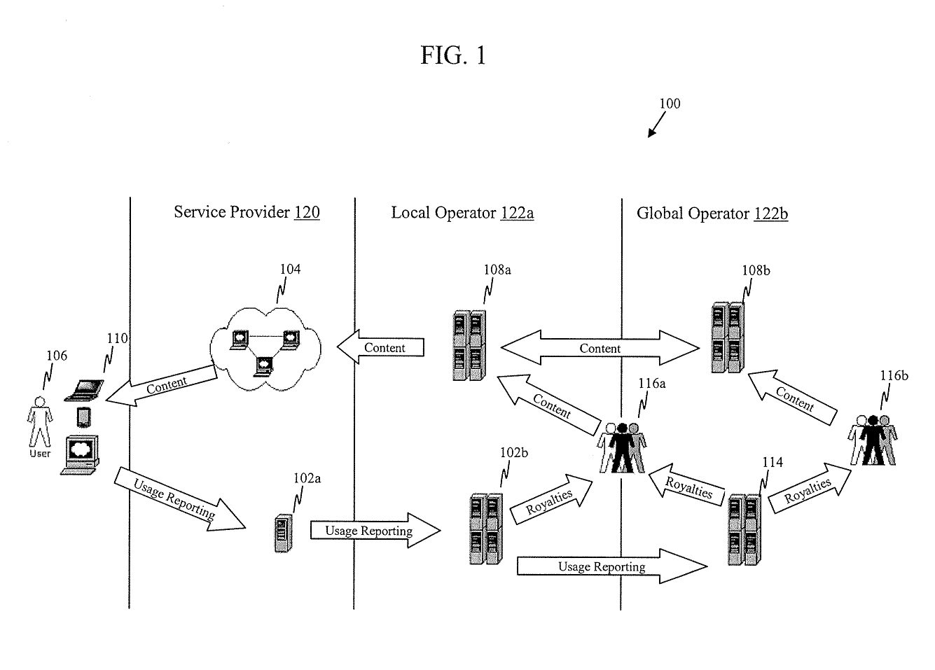

FIG. 1 is a high-level diagram of a system 100 according to various embodiments of the present inventions, illustrating the flow of content, usage information, and royalties among various components of the system. System 100 can include one or more content servers, such as a local content server 108a located at local operator 122a and/or a global content server 108b located at global operator 122b, for storing various content provided by content owners 116a, 116b. Local content server 108a can, for example, receive and store content from local content owners (e.g., local publishers) 116a, and global content server 108b can receive and store content from global content owners (e.g., global publishers) 116b. Further, local content server 108a and global content server 108b may further exchange content with one another.

User 106 can use any suitable network device 110 (e.g., networked computer, personal digital assistant, cell phone, etc.) to retrieve desired content that originated from content servers 108a, 108b using distribution network 104. Distribution network 104 may be a peer-to-peer (P2P) network with nodes located at service provider 120. Service provider 120 can be an Internet Service Provider (ISP). In this case, content server 108a may act as an initial seeder that delivers initial copies of content files to distribution network 104.

In some embodiments, distribution network 104 may be a P2P network that utilizes one or more levels of hierarchical super-peer servers (not shown). In such a P2P network, a super-peer server can act as a centralized server to a subset of client nodes in the P2P network, maintain an index of data available on the subset of client nodes, and answer queries sent from a client node or another super-peer server. In some embodiments, super-peer servers can be used to provide a desired quality of service (QoS) to users. For example, if client nodes in the P2P network do not have sufficient bandwidth, processing power, and/or other resources available at a given time to serve one or more users, a super-peer server that has more bandwidth, processing power, and/or other resources may be queried by a user and may send one or more blocks of a requested file to the user to satisfy the users' requests. A super-peer server may be a computer located at service provider 120 with dedicated resources. Content may be downloaded or streamed to user 106.

The system is shown in FIG. 1 as used by an individual user. While the system could work with an individual user, the content system can be set up for distribution to people within a group, such as a building, a work facility, a college campus, a municipal community, or some other group of individuals. When this is the case, the providers of the content management system may need to contract only with the group leader, such as business management, university management, or municipal officials, for payment for the content. Individual users in such a case would typically be required to agree to usage contracts in which the individual users would then agree to not use the data in unauthorized ways.

Usage of content by user 106 can be tracked, counted, and/or reported to one or more usage tracking servers. For example, content usage may be first reported to usage tracking server 102a located at service provider 120, and further reported by server 102a to usage tracking server 102b located at local operator 122a. Server 102b may further report content usage to global accounting server 114. Usage tracking servers 102a, 102b and/or (global accounting server 114 can administer rights and ownership of various content to be distributed to users (e.g., user 106). Based on reported content usage, usage tracking server 102b and/or global accounting server 114 can calculate and distribute royalties to content owners 116a and/or 116b respectively.

As shown in FIG. 1, local operator 122a, which can include local content server 108a and local usage tracking server 102b, may act as an intermediary between service provider 120 and global operator 122b for content distribution and usage reporting. Local operator 122a can communicate with one or more service providers (e.g., service provider 120) and can provide centralized administration for a particular territory (e.g., a state or a country). Local operator 122a and/or local service provider 120 can provide a user interface that is customized for the particular territory and/or the service provider so that user 106 can easily search and retrieve desired content. For example, the user interface may be customized with language(s) used in the particular territory. As another example, a university service provider may provide the university community a unique user interface that provides users easy access to educational materials.

Although FIG. 1 shows local operator 122a acting as an intermediary between service provider 120 and global operator 122b for content distribution and usage reporting, this need not be the case. In alternative embodiments, contents may be delivered directly from, e.g., global content server 108b to distribution network 104, and content usage may be sent to global accounting server 114 directly from device 110 and/or usage tracking server 102a.

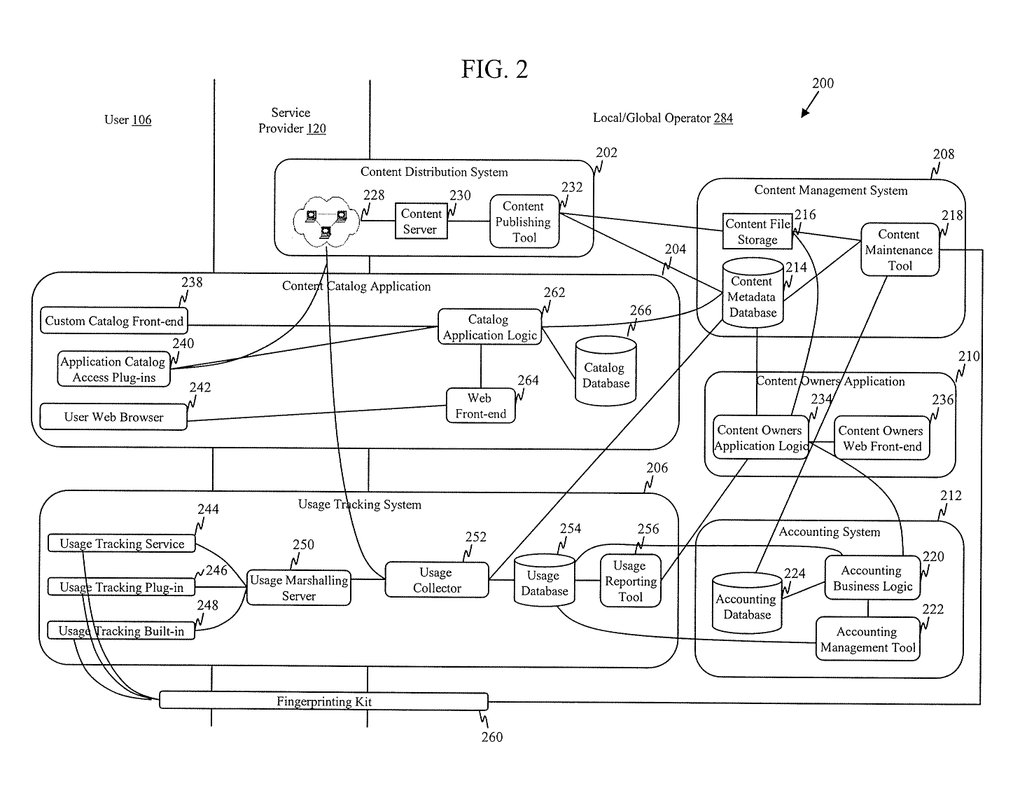

FIG. 2 is a block diagram of system 200 illustrating various embodiments. System 200 includes various subsystems, for example, fingerprinting kit 260, content distribution system 202, usage tracking system 206, content management system 208, content catalog application 204, content owners application 210, and/or accounting system 212. Each of these subsystems can be operated by one or more of user 106, service provider 120, and/or local (and/or global) operator 284, i.e., each of these subsystems can be located in different locations and/or can have functions that are distributed over multiple locations. In addition, different subsystems of system 200 that reside at a particular location may be installed and/or combined in a single computer or device. For example, usage tracking service 244 of usage tracking system 206 and user web browser 242 of content catalog application may be installed in a single user device.

Fingerprinting kit 260 is provided for fingerprinting content to provide a shortened form that can be used to represent and identify the content. It can be used by various subsystems of system 200, for example, usage tracking system 206, and content management system 208 to perform fingerprinting tasks. Fingerprinting kit 260 can be a library of fingerprinting functions designed to perform file-based or content-based fingerprints on all types of media files, including, but not limited to, audio files, video files, documents, executables, and/or images. In some embodiments, fingerprinting kit 260 can first analyze the file presented for fingerprinting and determine the type of the file, and then apply appropriate fingerprinting algorithm(s) according to the file type. Fingerprinting kit 260 may, for example, include libraries for file-hash fingerprinting for use on documents and executables, textual fingerprinting for use on text files, audio fingerprinting for use on audio files (e.g., MPEG-1 Audio Layer-3 (MP3) files, Waveform Audio Format (WAV) files, and the like), video fingerprinting for use on video files, and/or image fingerprinting for use on still images. Fingerprinting kit 260 may use any suitable fingerprinting algorithm. Fingerprinting kit 260 can also generate one or more fingerprints representing one or more segments of a content file. For example, when a particular segment of a media file is played, fingerprinting kit 260 may be used to generate fingerprint(s) for that particular segment.

Content management system 208, which may be located at local (and/or global) operator 284, can be used to import, store, and maintain digital content. Content management system 208 can include content file storage 216 for storing the large volume of content files maintained by system 200. Storage 216 can be used to retain authoritative copies of all content managed by local (or global) operator 284.

Content management system 208 can also include a content metadata database 214 for storing metadata associated with the managed content. Information stored in content metadata database 214 can include content details (e.g., title and author), content identification codes (e.g., International Standard Recording Code (ISRC), or International Standard Book Number (ISBN), International Standard Musical Work Code (ISWC)), and/or cross-references to content file storage 216 (i.e., locations where content items are stored in content file storage 216). For a single content item, content metadata database 214 may include multiple cross-references to content file storage 216 because the content item may be stored as multiple content files, for example, using different compression formats. Furthermore, content metadata database 214 can include cross-references to one or more distribution networks, and/or links where the content may be retrieved (e.g., BitTorrent links in P2P networks), which may differ for different service providers. In addition, content metadata database 214 can include a fingerprint database (not shown) that stores one or more fingerprints for each content item. A single content item may be fingerprinted using one or more algorithms on one or more content files.

This description sometimes refers to “content” or to a “content item” or a “content file.” A content item or content file can be any identifiable piece of content and can include an article, audio clip, video clip, executable, or text file. In addition, a content item can also be said to have multiple content items within it. For example, an article could have text and images, in which case the text and each of the images could be considered as and treated as, separate content items. In the case of a video clip, the content item could be considered the video clip with a combination of moving images and an audio file, or the audio and video can each be considered content items within one larger content item. Generally, a content item would not refer to multiple unrelated pieces of media just because they were stored in the same memory.

Content metadata database 214 can also include information relating to content permissions, such as territories where a license is obtained for a content item, permission to extract or combine music, lyrics, dialog, and images for creating derivative works (such as translations or music soundtracks), sampling of work fragments for recombination into new works (mash-ups or overlays), remixes, and/or moral rights restrictions (e.g., restrictions on use of the content as political messages). In addition, content metadata database 214 can include details regarding whether or not a work is derived from another source, for example, a derivative works registry, to track the paternity chain of derived works. Alternatively, part or all of the ownership information may be stored in accounting system 212 (e.g., in accounting database 224) for operational efficiency considerations.

Content management system 208 can further include content maintenance tool 218 for importing digital content files and associated metadata from various sources. The actual digital files may be transmitted by any suitable means including, for example, file uploading or manual importing from a physical medium. Metadata may also be acquired by any suitable means such as an Extensible Markup Language (XML) dump from an external database and/or manual entry. Using content maintenance tool 218, digital content files can be stored in content file storage 216, and content metadata can be stored in content metadata database 214. Content maintenance tool 218 may also be used to collect and store content ownership metadata in accounting database 224, provide bulk-import capabilities to allow the importing of large volumes of content, and/or generate digital content files from a provided digital content file in alternative formats, which may also be stored in content file storage 216.

Furthermore, content maintenance tool 218 can generate one or more digital fingerprints of the digital content using fingerprinting kit 260. When content files are added to content file storage 216, fingerprinting kit 260 can be used to generate fingerprints for the content files. The generated fingerprints can be added to content metadata database 214 through content maintenance tool 218.

Content distribution system 202 may be located at various service providers (e.g., service provider 120) and/or local (and/or global) operators (e.g., operator 284). Content distribution system 202 can include, for example, network 228, content server 230, and/or content publishing tool 232. Content distribution system 202 can be designed to allow the distribution of large amounts of digital content (e.g., music, movies, documents, or executables) to a large number of clients on multiple platforms. For example, network 228, which may be a P2P network, may utilize one or more levels of super-peer servers as described above to provide adequate quality of service (QoS) for content distribution. To protect user privacy, network 228 may use a P2P protocol such as Freenet which provides enhanced user anonymity. Such a protocol can make it difficult for administrators or other users to determine which content has been requested by any given user. Content server 230 may be a P2P seeding server and may act as an initial seeder of content files. Although server 230 and network 228 are shown as separate entities in FIG. 2, server 230 may be considered a part of network 228.

Content publishing tool 232 can be used for releasing content files for consumption by end users. Content publishing tool 232 allows administrators to determine which content from content management system 208 is to be released for distribution to customers of various service providers. Content publishing tool 232 can combine content metadata from the content metadata database 214 with digital content files from content file storage 216, and can release those files to content server 230.

Content server 230 can be maintained by local (and/or global) operator 284 and/or service provider 120. Server 230 can take account of content metadata for any given content file before serving it to network 228. Using this functionality, availability of certain content may be restricted to only certain service providers based on subscription agreements. For example, a service provider serving a university community may choose to only subscribe to education related content, and a content server may take this into account and only distribute education related content to network(s) operated by the service provider. In some embodiments, server 230 and/or network 228 can collect content usage data (e.g., number of times a content is downloaded) and communicate the collected content usage data back to usage tracking system 206. In this case, the content usage data can be tagged with metadata uniquely identifying the content.

Network 228 (which may include content server 230) may utilize known P2P protocols such as BitTorrent. In some embodiments, network 228 can utilize a “block prioritization” method to efficiently enable streaming playback of large content files such as videos. Unlike BitTorrent, by which a P2P client can download blocks of a large file from various peer nodes in a random order, network 228 can use a protocol that enables a P2P client to prioritize the blocks and to download high priority blocks first. Using such a “block prioritization” method, a P2P client does not have to download the whole file before playing the file. Instead, the P2P client may download a portion of the file (e.g., a video), start playing the video, and at the same time determine which other blocks of the file will be needed soon for playing and download these blocks in a prioritized manner. Such a “block prioritization” method is particularly suitable for streaming video applications.

Usage tracking system 206 can be used to gather data on the usage of content by individual users (e.g., user 106). Content usage data can be used for determining the amount of royalty payments to be distributed to content owners. Usage tracking system 206 can be used to assess the relative usage among various content files as well as absolute usage of any given content file. Usage tracking system 206 can receive and process content usage data collected by content distribution system 202 as described above. In addition, usage tracking system 206 can collect content usage data using software installed at user devices (e.g., networked computers, personal digital assistants, cell phones, etc.).

Usage tracking system 206 can include usage tracking service 244, usage tracking plug-in 246, and/or usage tracking built-in 248 located at a device used by user 106. For each device used by user 106, one or more of usage tracking service 244, usage tracking plug-in 246, or usage tracking built-in 248 may be used to track content usage on that device. Usage tracking system 206 can also include usage marshalling server 250, usage collector 252, usage database 254, and/or usage reporting tool 256, which may be located at service provider 120 and/or operator 284.

By using client side tracking via a user-side device that includes usage tracking service 244, usage tracking plug-in 246, and/or usage tracking built-in 248, usage tracking system 206 need not depend upon network 228 or any other content distribution network to collect usage data. For example, usage tracking system 206 can track usage of content that is acquired by means other than using a distribution network (e.g., content that is acquired from a physical medium or email). Content usage data that can be acquired may include number of content file accesses (opening, playing, etc.), duration of content file accesses, time when the content file is opened, which segment(s) of the content file is played or otherwise used, what application opened the content file, copying of the content file to external media (e.g., CD or DVD), copying of the content file to removable memory devices (e.g., iPods, memory devices using Universal Serial Bus (USB) drives), and/or other information about uses.

In some embodiments, usage tracking system 206 can combine usage data obtained from both a content distribution network (e.g., network 228) and from client-side tracking to achieve higher accuracy. For example, data collected by a distribution network (e.g., network 228) can be particularly useful for establishing a usage baseline for very low-utilization content, because every single download of a content file can be recorded by the distribution network (e.g., network 228). In addition, data collected by a distribution network (e.g., network 228) can be used for establishing usage norms of contents. By comparing these data with data collected by usage tracking system 206, attempts to “cheat” usage tracking system 206 (e.g., an owner of a content artificially inflating usage counts of the content) can be detected.

Usage tracking service 244 can be a program installed on a large number of user devices. Usage tracking service 244 can run as an unobtrusive background process that can monitor file-system access, audio output buffer, video output (screen) buffer, and/or some combination thereof. Usage tracking service 244 can be implemented, for example, as a kernel extension on any suitable operating system such as Windows, Mac OS, Unix and/or Linux. On Windows-based systems, usage tracking service 244 may incorporate a file system filter driver or mini filter for file access. On the Apple OS X platform, usage tracking service 244 may employ the Kernel Authentication subsystem, or kauth. On the Linux platform, usage tracking service 244 may employ the inotify event-monitoring system.

In some embodiments, when usage tracking service 244 determines that the system has accessed a content file for playback, it can check a cached lookup table to determine if the content file has been fingerprinted before. If there has not been a fingerprint made previously, service 244 uses fingerprinting kit 260 to generate one or more fingerprints of the content file. If a fingerprint is already cached, usage tracking service 244 uses the cached fingerprint to reduce processor load. In some embodiments, fingerprinting may be performed by usage tracking service 244 when a media content file is being played. Alternatively, fingerprinting tasks may be queued and performed during periods of low processor load.

In one embodiment, usage tracking service 244 can check with a file identification database, such as the fingerprint database in content metadata database 214, to see if the content file is registered with content management system 208. If the content file is not registered with system 208, usage tracking service 244 can disable usage tracking and/or reporting with respect to the particular content file, so that content usage is reported only for content files that have been previously registered with system 208. Usage tracking service 244 may also disallow the unregistered content file from being transferred by an associated file transfer application to another device or over a network. Alternatively, usage tracking service 244 reports content usage for all content files without checking whether the content files have been registered or not.

Usage tracking service 244 can collect information regarding content usage. For example, service 244 can record the length of time that a content file was played (or otherwise used) by user 106 and the portion(s) of the content file that was played (or otherwise used). Service 244 can also record events such as copying of the content file to external media (e.g., CD or DVD) and/or to removable devices (e.g., iPods, memory devices using Universal Serial Bus (USB) drives). If a known removable device that contains content files is disconnected and then reconnected to the user device, service 244 may extract content usage information from the removable device, if available.

Usage tracking service 244 can then send the generated fingerprint(s) and content usage information upstream to usage marshalling server 250 and/or usage collector 252. In some embodiments, usage tracking service 244 can periodically compile a list of content file accesses and related information, and send the list upstream for processing when the user device is online. Using the generated fingerprints, usage collector 252 can identify various contents by searching for the fingerprints in content metadata database 214.

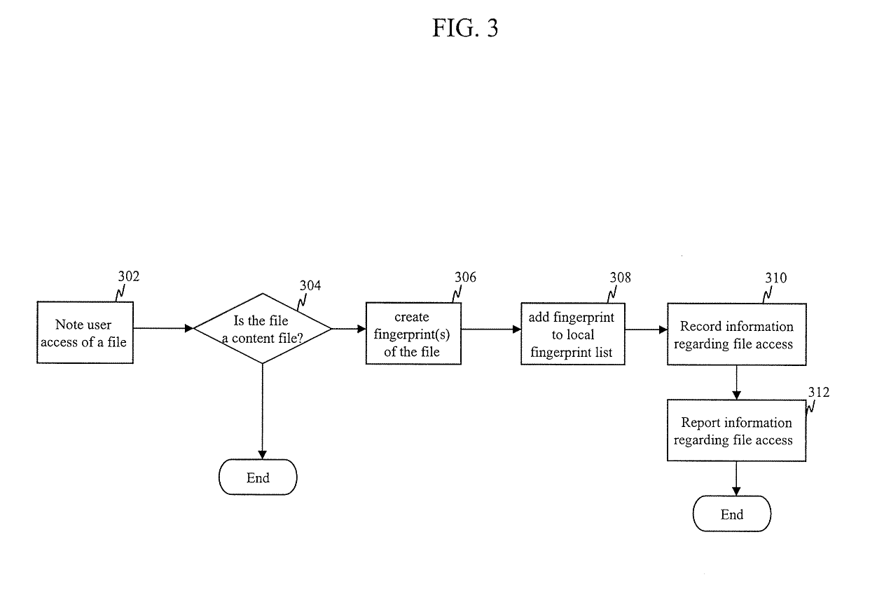

FIG. 3 is a flow chart illustrating the operation of usage tracking service 244 when a content file is accessed. At 302, when a user starts to play, copy, or otherwise access a file using a device (e.g., networked computer, personal digital assistant, cell phone, etc.), it can be noted and recorded by usage tracking service 244 located on that device. At decision step 304, usage tracking service 244 can determine whether the file is a content file. This determination can be made by checking the file extension names and/or by any other suitable techniques. If it is determined that that the file is a content file, service 244 can create a fingerprint of the file for identification purposes at 306. At 308, service 244 can add the fingerprint to a local fingerprint cache or list. At 310, service 244 can record the duration of file access, the portions of content file that is accessed, and/or other information relating to file access. This recording may be performed, for example, when file access is over. At 312, information relating to file access that is recorded at 310 may be reported, for example, to usage marshalling server 250 and/or usage collector 252 shown in FIG. 2. This may occur periodically if the device is online and can be pushed by the user or pulled by the server by polling users.

Referring again to FIG. 2, usage tracking plug-in 246 and usage tracking built-in 248 can serve similar functions as usage tracking service 244. Usage tracking plug-in 246 can be an application based software component that can be integrated with media playback software on major platforms. Usage tracking built-in 248 can be a firmware based software component for third-party integration with standalone devices such as network connected mobile phones and media players. Usage tracking plug-in 246 and usage tracking built-in 248 can utilize fingerprinting kit 260 that is optimized for the particular platform on which they operate, and may interact with an already-installed usage tracking service 244 to increase accuracy and efficiency.

Usage marshalling server 250 can be used to collect and pre-process content usage data at the service provider level before delivering usage reports upstream to usage collector 252. Alternatively, content usage data may be sent to usage collector 252 directly. Usage collector 252 may be maintained by operator 284 and can collect usage data from multiple sources, including, for example, content server 230, network 228, usage marshalling server 250, and end-user usage tracking service 244. Usage collector 252 may also collect usage data from other seeding servers, distribution networks, marshalling servers, and end-user devices not shown in FIG. 2. Usage marshalling server 250 can decrypt any encrypted incoming data and perform any suitable consistency and validity checks before storing the data in usage database 254.

Usage reporting tool 256 can provide detailed reports and summaries on content usage. These reports may be used for any number of purposes including fraud prevention, marketing, and/or accounting. However, content usage reports can include private information regarding the user that needs to be protected.

Referring again to FIG. 2, accounting system 212 can include accounting database 224, accounting business logic 220, and/or accounting management tool 222. As described above, accounting database 224 can include content ownership information such as a derivative works registry. Accounting database 224 can also include predefined royalty rules for calculating royalty payments. The rules can be based on criteria such as total downloads, total individual access of a file, newness of a piece of content, and/or individual users' customized personal content catalogs.

Accounting business logic 220 can include royalty calculation and distribution process. This can be an automatic process that is periodically run (e.g., on a monthly basis) that takes information from content owners application logic 234 (described below), accounting database 224, and/or usage database 254. Based on these information and predefined royalty rules (e.g., royalty rules stored in accounting database 224), business logic 220 can determine royalty payouts for each piece of content. Once royalty payouts are determined, they can be saved to accounting database 224. Payouts can be made using the content owner's preferred method (e.g., check, Electronic Data Interchange (EDI), PayPal), after which royalty payout reports can be generated. Content owners can review royalty payout reports using content owners application 210.

According to various embodiments, system 200 may provide a group of users a large pool of content and require each user, or the group of users, to pay a flat subscription fee (e.g., a flat monthly fee) regardless of content usage by each individual user. In this case, accounting business logic 220 can calculate royalty payments according to relative usage of different contents in the content pool (i.e., usage of a single content relative to total usage of contents in the content pool). In other words, the total amount of subscription fee collected from the group of users is distributed to content owners according to relative usage of the contents instead of absolute usage. In this case, therefore, usage tracking system 206 need not provide accounting system 212 with a completely accurate account of content usage; a certain level of accuracy regarding relative usage can enable accounting system 212 to calculate royalty payments fairly.

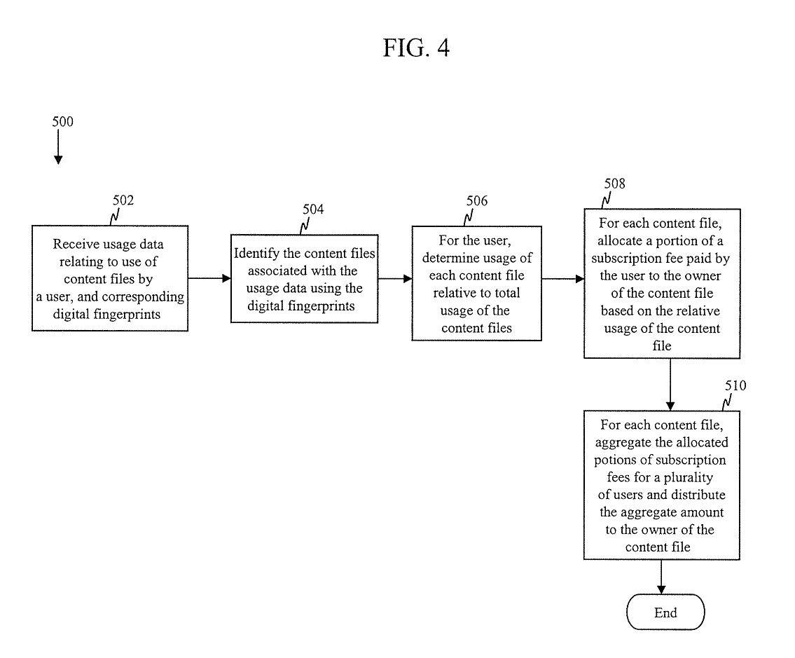

FIG. 4 illustrates such a method that can be used by system 200 for calculating royalty payments. At step 502, usage collector 252 shown in FIG. 2 receives usage data relating to a users' usage of content files along with digital fingerprints. At step 504, each of the content files can be identified with a received digital fingerprint and associated with corresponding usage data. At step 506, accounting system 212 can determine, for the user, usage of each content file relative to total usage of the content files by the user. This relative usage may include, for example, time that a content file is played (or otherwise accessed) relative to total time that the user spent on the content files during a certain time period. This relative usage may also be calculated in any other suitable manner using one or more different types of usage information. For example, the relative usage may be based on the number of times that the content file is accessed (and/or copied) relative to the total number of times that the content files are accessed (and/or copied) by the user. At step 508, for each content file, accounting system 212 can allocate a portion of a subscription fee paid by the user to the owner of the content file, based on the relative usage determined in step 506. At step 510, accounting system 212 can aggregate the allocated portions for a group of users and distribute the aggregate payment to the owner of the content file.

It is possible that users of system 200 could try to artificially inflate royalty payments by secretly controlling other devices remotely (e.g., by use of a malicious agent) and use these other devices to download or play certain content. Various technologies or strategies may be employed to thwart these attempts. For example, usage tracking system 206 can filter usage reports so that they are only allowed from machines that show network addresses on licensed networks.

Usage tracking system 206 and/or accounting system 212 may also perform statistical analysis of aggregate usage, making sure, for example, that the distribution of various metadata for each content item follows normal patterns. In some embodiments, usage tracking system 206 and/or accounting system 212 may statistically analyze groups of usage data, each group corresponding to, for example, a region or a service provider from which the usage data is collected, and determine usage of a content item relative to total usage for each group. This relative usage of the content item can then be compared across the different groups to detect any anomalies. For example, if the relative usage of the content item for the different groups does not follow a normal distribution, it may indicate that bogus usage information may be reported in some groups. Usage tracking system 206 and/or accounting system 212 may also obtain and analyze content download information from, for example, network 228, and compare that with usage information obtained by client-side usage tracking system 206. For example, if the number of downloads for a content item relative to total downloads as reported by network 228 substantially differs from relative usage of the content as reported by usage tracking system 206 for the same network, it is likely that false usage information is reported.

User 106 served by service provider 120 can access network 228 using content catalog application 204 and/or any other suitable means. Content catalog application 204 can include a web-based application accessible through standard Web browser 242, customized catalog front-end 238 specific to a given class of client, application catalog access plug-in 240 to an existing media management application, and/or any other suitable means. Content catalog application 204 can also include catalog application logic 262 and catalog database 266. Catalog application logic 262 can interface with content metadata database 214 and catalog database 266. Catalog database 266 can be used, for example, to store customized content catalogs for different users and/or organizations. System 200 can allow multiple and different types of applications to access content catalogs stored in catalog database 242.

Content catalog application 204 can collect and display information on available content, allowing users to browse through content and select items for preview and/or download. Using customized content catalogs stored in catalog database 266 and content metadata stored in content metadata database 214, catalog application logic 262 can generate customized portal Web pages displaying available content to a particular user or organization. In some embodiments, it can provide usable peer-to-peer links (using BitTorrent or a similar protocol) to allow users to download content from network 228 provided by service provider 120. Content catalog application 204 can also be used to access recommendation engines, save content locally, create and link to playlists, create and join groups, collaborate on creating contents, and/or social networking.

Content owners application 210 can be a web-based application to allow content owners to interface with system 200. It can be used to import content, enable content metadata management including territory permissions and ownership information, report content usage to content owners, and/or provide accounting reports and account management.

The description has referred to systems, subsystems, databases, processors, and servers. These terms should be understood broadly to cover a wide range of hardware and/or software that can be used to implement these components. In addition, what is described as separate servers could be located together in one location (co-located) or could even share processing hardware but use different software. The various subsystems could be implemented substantially all in hardware or software, but would typically be implemented primarily with software executed on a processor, that could also implement other software that implements other systems. The processors and servers can be general purpose devices for implementing any appropriate software, or could be application-specific processors or controllers for devices, such as appliances.

In the description above, there are references to databases, but any form of memory that is suitable to hold the data could be used. There are references to multiple databases, but multiple databases or storage media can be co-located, or could be multiple tables within the same physical database. References to multiple databases could refer to physically separate databases stored at remote locations.

Other embodiments, extensions, and modifications of the ideas presented above are comprehended and within the reach of one skilled in the field upon reviewing the present disclosure. Accordingly, the scope of the present invention in its various aspects is not to be limited by the examples and embodiments presented above. The individual aspects of the present invention, and the entirety of the invention are to be regarded so as to allow for modifications and future developments within the scope of the present disclosure. The present invention is limited only by the claims that follow.

1. A method for recording and reporting content usage, comprising:
determining that a content file is accessed by a user using a network device;
recording, at the network device, usage data relating to the user's access of the content file;
creating a digital fingerprint of at least a portion of the content file at the network device; and
reporting the recorded usage data and the created digital fingerprint to a server.

2. The method of claim 1, wherein the usage data comprises at least one of a number of times that the content file is accessed by the user, duration that the content file is accessed by the user, information regarding copying of the content file to external media, and information regarding copying of the content file to a removable memory device.

3. The method of claim 1, wherein the network device comprises a computer.

4. The method of claim 1, wherein the network device comprises a personal digital assistant.

5. The method of claim 1, wherein the network device comprises a cell phone.

6. The method of claim 1, further comprising integrating a kernel extension in the network device for the determining and the recording.

7. The method of claim 1, wherein creating a digital fingerprint of the content file comprises:
determining a type of the content file; and
selecting a fingerprinting algorithm to be applied to the content file based on the type of the content file.

8. The method of claim 1, further comprising:
determining that the content file is registered with the server using the created digital fingerprint.

9. The method of claim 1, wherein the network is a peer-to-peer network, further comprising:
retrieving the content file by use of the peer-to-peer network.

10. The method of claim 9, wherein the retrieving further comprises retrieving the content file from one or more super-peer servers in the peer-to-peer network when other servers in the peer-to-peer network cannot provide a desired quality of service.

11. The method of claim 9, wherein the retrieving further comprises prioritizing content file blocks to be retrieved.

12. The method of claim 1, further comprising:
identifying the content file at the server using the digital fingerprint.

13. The method of claim 1, further comprising:
determining, at the server, a payment to be distributed to an owner of the content file based on the usage data.

14. A computer program product for recording and reporting content usage, comprising:
at least one computer readable medium, readable by a network device;
instructions, provided on the at least one computer readable medium, for determining that a content file is accessed by a user using the network device;
instructions, provided on the at least one computer readable medium, for recording, at the network device, usage data relating to the user's access of the content file;
instructions, provided on the at least one computer readable medium, for creating a digital fingerprint of at least a portion of the content file at the network device; and
instructions, provided on the at least one computer readable medium, for reporting the recorded usage data and the created digital fingerprint to a server.

15. The computer program product of claim 14, wherein the usage data comprises at least one of a number of times that the content file is accessed by the user, duration that the content file is accessed by the user, information regarding copying of the content file to external media, and information regarding copying of the content file to a removable memory device.

16. The computer program product of claim 14, further comprising instructions, provided on the at least one computer readable medium, for integrating a kernel extension in the network device for the determining and the recording.

17. The computer program product of claim 14, wherein the instructions for creating a digital fingerprint of the content file comprises:
instructions, provided on the at least one computer readable medium, for determining a type of the content file; and
instructions, provided on the at least one computer readable medium, for selecting a fingerprinting algorithm to be applied to the content file based on the type of the content file.

18. The computer program product of claim 14, further comprising:
instructions, provided on the at least one computer readable medium, for determining that the content file is registered with the server using the created digital fingerprint.

19. The computer program product of claim 14, wherein the network is a peer-to-peer network, further comprising:
instructions, provided on the at least one computer readable medium, for retrieving the content file by use of the peer-to-peer network.

20. The computer program product of claim 19, wherein the instructions for retrieving further comprises instructions, provided on the at least one computer readable medium, for retrieving the content file from one or more super-peer servers in the peer-to-peer network when other servers in the peer-to-peer network cannot provide a desired quality of service.

21. The computer program product of claim 19, wherein the instructions for retrieving further comprises instructions, provided on the at least one computer readable medium, for prioritizing content file blocks to be retrieved.

22. The computer program product of claim 14, further comprising:
instructions, provided on the at least one computer readable medium, for calculating, at the server, a royalty payment to be distributed to an owner of the content file based on the usage data.

23. A network device, comprising:
means for determining that a content file is accessed by a user using the network device;
means for recording usage data relating to the user's access of the content file;
means for creating a digital fingerprint of at least a portion of the content file; and
means for reporting the recorded usage data and the created digital fingerprint to the server.
